(19) United States
(12) Patent Application Publication
(10) Pub. No.: US 2007/0162550 A1
(43) Pub. Date: Jul. 12, 2007

(54) VEHICLE-TO-VEHICLE INSTANT MESSAGING WITH LOCATIVE ADDRESSING

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/610,494

(22) Filed: Dec. 13, 2006

Related U.S. Application Data
(60) Provisional application No. 60/756,898, filed on Jan. 6, 2006.

(51) Int. Cl. G06F 15/16

(52) U.S. Cl. 709/206

(57) ABSTRACT

An automobile-to-automobile instant-messaging system that enables a user of a first automobile to selectively send a communicative message to a user of a second automobile, the communicative message being addressed to the second automobile based at least in part upon its location with respect to the first automobile. In some embodiments the message is addressed also based upon the road and/or direction of travel of the second automobile. In an example embodiment, the system comprises a locative server in wireless communication with processors of each of the first and second automobiles, the locative server repeatedly receiving locative data from each automobile indicating its substantially current geospatial location; and wherein messaging data is sent to the second automobile that originates from the first automobile, the sending of the messaging data being dependent at least in part upon a determined spatial proximity between the first automobile and the second automobile.

This application is a nonprovisional of U.S. patent application No. 60/756,898, filed Jan. 6, 2006, entitled LOCATION-BASED VEHICLE TO VEHICLE INFORMATION EXCHANGE which is incorporated herein in its entirety by this reference.

### BACKGROUND OF THE INVENTION

1. Field of the Invention

The present invention relates generally to vehicle-to-vehicle communication and, more particularly, to enabling a user of a first automobile to selectively send a communicative message to a user of a second automobile, the addressing of the message being based at least in part upon the relative geospatial locations of the first and second automobiles.

2. Discussion of the Related Art

Many systems have been developed in the past that enable users to communicate between moving vehicles, including cell phones, CB radios, even the common car horn. Of today's technologies, the common car horn is the only readily available means by which a user may selectively communicate with the vehicles around him or her without any prior addressing knowledge of other vehicles or user's of those vehicles. Unfortunately the common car horn is not a vehicle specific means of communication, broadcasting a non-specific non-targeted generic audio alert to all vehicles within earshot of the vehicle blowing its horn. This causes many problems because a user may honk his horn at a vehicle in front of him, but this sound is generally heard by the users of many vehicles that are not the intended recipients. This causes confusion in many situations, alerting and/or concerning vehicle drivers who need not be bothered. In addition the car horn is generally a generic alert sound, providing no clear messaging information from vehicle to vehicle. For example, a user of a first vehicle may be trying to pass a user of a second vehicle and may wish to communicate this intent to the user of the second vehicle. The user of the first vehicle may honk his horn or even flash his headlights because these are the only communication channel available to the user, but such generic alert signals are generally non-informative and are likely to be misinterpreted by the users of vehicles who receive them. In fact, a horn blast that is intended as a friendly indication that a user of a first vehicle intends to pass a second vehicle is easily taken by the user of the second vehicle as an offense, leading to road rage, miscommunication, and/or confusion.

Furthermore because the other vehicles in the immediate vicinity of a first user's vehicle are likely to contain strangers to the first user, the first user is unlikely to have any electronic communication addressing information about the other vehicle or users of the other vehicle—i.e. no phone number, email address, text messaging address, user name, user ID, URL, or other means by which a communication message may be addressed to that other vehicle.

### SUMMARY OF THE INVENTION

Several embodiments of the invention advantageously address the needs above as well as other needs by providing methods and apparatus for enabling a first vehicle to gain information about and/or send a message to a second vehicle.

In one embodiment, the invention can be characterized as an automobile-to-automobile instant-messaging system comprising a first automobile and a second automobile, each automobile comprising a vehicle chassis for transporting a user on a road of travel, a messaging user interface for enabling the user to selectively indicate message-sending intentions, a messaging display for selectively displaying a message to the user in at least one of an audio or visual form, one or more locative sensors for determining a substantially current geospatial location and direction of travel of the automobile, a wireless communication link for transmitting locative data and message data from the automobile to a locative server, and a processor operationally connected to the messaging user interface, the one or more locative sensors, and the wireless communication link, the processor running messaging routines; and the locative server comprising one or more processors, the locative server in wireless communication with each of said first and second automobiles, the locative server repeatedly receiving and storing locative information from each of said first and second automobiles indicating the substantially current geospatial location of that automobile; wherein the message is routed to the second automobile from the first automobile dependent at least in part upon a detected interaction between the user of said first automobile and the messaging user interface of the first automobile and a determined spatial proximity between the first automobile and the second automobile.

In another embodiment, the invention can be characterized as an automobile-to-automobile instant-messaging system comprising a locative server in wireless communication with processors of each of a first automobile and a second automobile, the locative server repeatedly receiving locative data from each of said first and second automobiles, the locative data indicating the substantially current geospatial location of the respective automobiles; wherein messaging data is sent to the second automobile that originates from the first automobile, the messaging data being sent dependent at least in part upon a determined spatial proximity between the first automobile and the second automobile; and a user interface in the first automobile adapted to receive a user interaction indicating the user's desire to send the messaging data to another automobile in the local vicinity of the first automobile.

In a further embodiment, the invention may be characterized as a method for automobile-to-automobile instant-messaging comprising sending a message to a second automobile in response to a user request imparted upon a messaging user interface of a first automobile, the sending being dependent at least in part upon a determined spatial proximity between the second automobile and the first automobile, and a determined common direction of road travel of the second automobile and the first automobile.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates an example system configuration for a location-based vehicle to vehicle communication system enabled by the present invention

FIG. 2 shows two illustrated cars upon an illustrated road and indicates schematically part of the system architecture for how these cars may communicate based upon their relative location using example methods and apparatus of the present invention.

FIG. 3 shows an example embodiment of a messaging user interface of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims. The present embodiments address the problems described in the discussion of the related art while also addressing other additional problems as will be seen from the following detailed description.

This invention relates generally to vehicle-to-vehicle information exchange. What is needed is a more specific, more expressive, and easy to use means of communication from vehicle to vehicle, enabling users of one vehicle to communicate a range of information to a specifically targeted other vehicle in his or her immediate vicinity.

Furthermore, what is needed is a selective means of addressing a second vehicle in close proximity to a first vehicle for use in vehicle-to-vehicle messaging.

Still further, because there may be a plurality of other vehicles in the immediate vicinity of a first user's vehicle, the first user wishing to message only a specific one of the plurality, there is a need for selecting a vehicle from a plurality of other vehicles as part of a vehicle-to-vehicle communication system. Similarly, because there may be a plurality of other vehicles in the immediate vicinity of a first user's vehicle and the first user may wish to message only a certain few of the plurality, there is a need for selecting a number of certain vehicles from a plurality of other vehicles as part of a vehicle-to-vehicle communication system.

The present invention is comprised of methods and apparatus that enable a user of a first vehicle (i.e. an automobile) to gain information about and/or send a message to a second vehicle (i.e. a second automobile) based upon the relative spatial location of the first and second vehicles and a user interaction with a electronic interface of said first vehicle. More specifically, the present invention enables a user of a first vehicle to selectively gain information about and/or send a message to a second vehicle that is driving directly in front of said first vehicle or a second vehicle that is driving directly behind said first vehicle by interacting with an electronic interface of said first vehicle. In some embodiment of the present invention, the information gained by said first vehicle from said second vehicle may include a make, model, year of manufacture, exterior color, license plate number, vehicle identification number, owner name, owner handle, owner defined message. In some embodiments of the present invention the message sent from said first vehicle to said second vehicle may include pre-scripted text message, a pre-recorded audio message, a pre-recorded video message, a real-time audio message, a real-time video message, or a non-verbal alert such as a digital honk sound indicator. In some embodiments of the present invention the user may select from among the vehicle directly in front of the first vehicle and the vehicle directly behind the first vehicle when performing an information access and/or a message sending function. In this way a user of a first vehicle may select a second vehicle from among a plurality of vehicles based upon the relative spatial location of the second vehicle with respect to the first vehicle and upon selection gain information about and/or send a message to the second vehicle. Thus a user of vehicles equipped with the methods, apparatus, and computer programs of the present invention may communicate with each other even if they do not have a phone number, email address, user ID, user name, or other vehicle or user identifier by which to address the communications. Instead a user may simply specify a target vehicle as being directly ahead or directly behind the user's own vehicle as a means of communication addressing. In this way a user of a first vehicle can communicate with one or more vehicle users in his or her immediately proximity without necessarily knowing who those users are prior to the communication. For example, a user of a first vehicle who is being tailgated by a user of second vehicle may send a digital message to the user of the second vehicle requesting that the user stop tailgating. Similarly a user of a first vehicle, who is planning to pass a second vehicle in front of him or her, may send a digital message to the user of the second vehicle politely informing the second vehicle user of the first vehicle user's intent to pass. In this way the unique addressing and messaging methods provided by the present invention enable users to selectively communicate alerts, intentions, greetings, concerns, and/or apologies between them, making driving a more social and interactive experience between users of proximate vehicles. Thus, the present invention may be utilized to communicate a variety of things such as, for example, that another vehicle is too close, has its brights on, has its blinker on, has a tail light out, and/or is going too slowly.

In addition, unique methods of the present invention are optionally provided that allow a messaged vehicle to send a response message to the vehicle from which the message was sent. In this way, for example, a user of a first vehicle who is being tailgated by a user of second vehicle may send a digital message to the user of the second vehicle requesting that the user stop tailgating AND the user of the second vehicle, upon receiving the message from the first vehicle, may send a response message—for example an apology or explanation. Thus the present invention enables selective messaging from a first vehicle to a second vehicle based upon the relative location of the second vehicle to the first vehicle AND enables response messaging from said second vehicle to said first vehicle.

The present invention operates by including one or more locative sensors within each enabled vehicle, the locative sensor providing data indicating the spatial location and direction of travel of the vehicle at a current moment in time. The locative sensors may include, for example, a GPS transducer that provides geospatial coordinates for the vehicle at a current moment in time. For example, a second generation GPS system created by the European Union is expected to soon provide GPS positional data to appropriately equipped transducers with a spatial accuracy of 1 meter or less. The locative sensor may be supplemented by additional information, such as vehicle relative travel information based upon wheel speed and car travel direction. The locative sensor may also include an orientational sensor, such as a magnetometer, for determining the heading direction of the vehicles travel. The system may also cross reference a database of known roads to increase the accuracy of locative determinations based upon sensor readings. The locative sensors may also receive information from land-based beacon reference points that increase the accuracy of positional determinations.

In addition to the locative sensor that provides spatial location and direction of travel information, enabled vehicles are equipped with a wireless communication link to one or more locative servers. The locative servers receive information from each vehicle relating to the location and direction of travel of the vehicles as well as a vehicle identifier by which each vehicle can be uniquely addressed. The vehicle identifier may be a unique ID, a unique internet URL, a unique data string, a unique phone number, or some other means by which each vehicle can be uniquely identified. This unique identifier that is specific to an individual vehicle at a particular moment in time is referred to herein as the Unique Vehicle Identifier or UVI. In some embodiments the unique vehicle identifier is based upon and/or includes the Vehicle Identification Number (VIN) of the vehicle. In other embodiments the unique vehicle identifier is based upon and/or includes the License Plate Number of the vehicle. In some embodiments the unique vehicle identifier is related to, based upon, and/or includes an identifier for the owner of the vehicle. In some embodiments the unique vehicle identifier is related to, based upon, or includes an identifier for the then current driver of the vehicle. Thus each vehicle enabled by the current invention provides locative information about its current position and direction of travel to a locative server along with a unique vehicle identifier that identifies the vehicle from among a plurality of other vehicles being tracked by the locative server. The locative server is operative to maintain a database of a plurality of currently active vehicles, each indexed by a unique identifier, the database including a substantially current location and direction of travel for each. In some embodiments the unique identifier used by the database is the same as or a derivative of the UVI for that vehicle. The database may also include a unique messaging address, for example a phone number, URL, or other addressing means by which digital communications can be uniquely directed to that particular vehicle. This address is referred to herein as the UMA or unique messaging address. In some embodiments the UMA and the UVA are the same. In some embodiments the UMA and UVA are different but relationally associated by said database.

Thus the present invention includes a locative server that communicates with a plurality of vehicles and maintains a database that includes substantially current spatial position information, direction of travel information, UVI information, UMA information, and optional additional information about each vehicle—for example make, model, year, color, current speed of travel, VIN, owner identification, or current driver identification. The locative server that performs such functions is referred to herein as the Vehicle Locative Server or VLS Server. The VLS server generally runs a software application that is referred to herein as the VLS application.

By current spatial position information and current direction of travel information it is understood that there will generally be some amount time lag that causes the most current locative data stored for some or all vehicles to reflect that vehicles location and/or direction of travel at a recent time in the past. It is therefore desirable for the current invention to keep such time lags as small as possible within the practical limitations of the technology employed. It is also generally desirable for the locative server to store a time-history of current locations for said plurality of vehicles, said time-history reflecting one or more previous but recent locations of each of said plurality of vehicles. It is also sometimes desirable for the locative server to store a current speed for each of said plurality of vehicles, said current speed being derived from speed data received from each vehicle, being derived from said time history of current locations for each vehicle, or a combination of both. Furthermore, in some embodiments of the present invention the VLS application running on the VLS server may be operative to predict a current location of a vehicle based at least in part upon the stored time-history of previous locations of that vehicle and/or a current speed of the vehicle and/or a current direction of travel of the vehicle.

In addition to tracking the current location of a plurality of vehicles, each having a local computing device interfaced wirelessly with the VLS server, the VLS application as disclosed herein may also be operative to store a unique vehicle profile for each of said plurality of vehicles, the unique vehicle profile including information such as the make, model, year, exterior paint color, city or state or country of ownership of the vehicle, owner name or identifier, owner address, or other similar information for each vehicle. The VLS application may also be operative to store access-preference information for each vehicle, the access-preference information describing and/ or limiting how other users may gain information about that vehicle and/or initiate communication with a user of that vehicle. For example, access-preference information may limit access to some or all information only to other users or vehicles of users who match certain criteria, possess certain characteristics, and/or meet certain security requirements. For example, certain information may be defined as access-restricted such that it may only be accessed by police users and/or users of police vehicles. Similarly, access-preference information may limit communication with a particular user (or vehicles) only to those who match certain criteria, possess certain characteristics, and/or meet certain security requirements. In some embodiments said certain security requirements includes a particular user possessing a password or satisfying some other authentication such as belonging to an official police organization. In some embodiments said certain criteria includes a particular user being a member of a particular social network or business organization or subscription service.

The VLS server is accessed by a plurality of vehicles, each of said vehicles employing a local computing device with wireless network capability and spatial location tracking capability using GPS transducers and/or other position and/or orientation determining components. The methods and apparatus as disclosed herein enable the local computing device of a first vehicle to access information about and/or initiate communication with a second vehicle based in whole or in part upon the relative location of said second vehicle with respect to said first vehicle. More specifically, the methods and apparatus as disclosed herein enable the local computing device of a first vehicle to access information and/or initiate communication through a local computing device of a second vehicle based upon input from a user of said first vehicle and a determination by said locative server that said second vehicle is located directly ahead of said first vehicle upon a particular road on which both said first and second vehicles are traveling. Similarly, the methods and apparatus as disclosed herein enable the local computing device of a first vehicle to access information and/or initiate communication through a local computing device of a second vehicle based upon input from a user of said first vehicle and a determination by said locative server that said second vehicle is located directly behind said first vehicle upon a particular road on which both said first and second vehicles are traveling. In addition the methods of the present invention enable a user of said first vehicle of enter input to said local computing device of said first vehicle to specify if said computing device of said first vehicle should access information about and/or initiate communication with a second vehicle that is located directly in front of said first vehicle or directly behind said first vehicle. Note, in some embodiments additional relative locations are supported including a second vehicle being located directly to the left of the first vehicle OR a second vehicle being located directly to the right of the first vehicle.

In some preferred embodiments, when a user of a first vehicle requests that information be accessed about and/or a message be sent to the vehicle directly ahead of the first vehicle, the VLS server finds this vehicle by finding the closest vehicle to the first vehicle that is (a) traveling upon the same road as the first vehicle, (b) traveling in the same direction as the first vehicle, (c) is in the same road lane of said first vehicle (if the road has a plurality of lanes in the direction of travel, and (d) is ahead of the said first vehicle in a directional computation axis that points along the direction of travel of said first vehicle upon the road that said first vehicle is upon. Similarly, when a user of a first vehicle requests that information be accessed about and/or a message be sent to the vehicle directly behind the first vehicle, the VLS server finds this vehicle by finding the closest vehicle to the first vehicle that is (a) traveling upon the same road as the first vehicle, (b) traveling in the same direction as the first vehicle, (c) is in the same road lane of said first vehicle (if the road has a plurality of lanes in the direction of travel, and (d) is behind the said first vehicle in a directional computation axis that points along the direction of travel of said first vehicle upon the road that said first vehicle is upon. In this way the VLS server may determine based upon stored current location information (and optionally stored current orientation information) which vehicle is likely to be the one that is current directly ahead of OR directly behind the first vehicle.

Once the VLS server determines a vehicle that is directly ahead of said first vehicle and/or determines a vehicle that is directly behind said first vehicle, the VLS server may enable the local computing device of the first vehicle to gain information about said second vehicle and/or initiate communication with said second vehicle.

In some embodiments the VLS server enables said local computing device of said first vehicle to gain information about said second vehicle by sending the data directly to said local computing device of said first vehicle. In such embodiments the VLS server may maintain within its database, some or all of the information that third parties may desire to access about each vehicle. For example, the VLS server may maintain information in its database about the make, model, year, color, owner name, current speed, even current driver name within its database and sends some or all of that data to vehicles that request such information (i.e. the first vehicle in this example). In some embodiments the information that the VLS server sends to the first vehicle about the second vehicle may be dependent upon privacy and/or security parameters and/or social networking information and/or access parameters stored for said second vehicle in said database. In some embodiments the information that the CLS server sends to the first vehicle may also be dependent upon privacy parameters and/or security parameters and/or social networking information stored for said first vehicle within said database. For example, if the first vehicle is a registered police vehicle and has certain security access parameter associated with it, more detailed information stored in the database for the second vehicle may be transferred to the first vehicle than if the first vehicle was a privately owned vehicle without special access privileges.

In some embodiments the VLS server enables said local computing device of said first vehicle to send a message to and/or initiate bi-directional communication with said second vehicle by routing information back and forth between said first vehicle and said second vehicle. To support such embodiment the VLS server may maintain within its database, communication addressing information about each of said vehicles. In this way the VLS server may relay a message from said first vehicle and/or route communications from said first vehicle to said second vehicle using a communication address for said second vehicle accessed from said database. Similarly the VLS server may relay a message from said second vehicle and/or route communications from said second vehicle to said first vehicle using a communication address for said first vehicle accessed from said database. In this way the VLS server may enable communication between said first and second vehicle without revealing the addressing information about either vehicle to the other vehicle, maintaining anonymity between vehicles (and users of vehicles). This ability for the VLS server to route messages and/or communications between said first vehicle and said second vehicle is a great benefit because it allows communications to be established between users of vehicles that come within proximity of each other without revealing any personal information and/or permanent addressing information of each vehicle (or user) to the other vehicle (or user). In other embodiments the VLS server may be operative to convey addressing information about said local computing device of said second vehicle to said local computing device of said first vehicle, and vice versa, enabling the two vehicles to communicate directly through an intervening communication network. In some embodiments both the anonymous communication method (achieved with the VLS server acting as the intermediary for routing information between vehicles) and the direct communication method (achieved by the VLS server passing vehicle communication addressing information about one vehicle to another) may be selectively enabled depending upon the situation at hand.

The present invention may be implemented as a managed networking service that is provided by a system operator who administers the system and manages information accesses and/or communication initiations between registered vehicles. In particular, the system operator runs at least one VLS server that tracks the locations of a plurality of active vehicles and programmatically identifies based upon received data and computation, when a first of said vehicles requests information about and/or requests communication with a second of said vehicles that is located directly in front of or directly behind the first of said vehicles.

The VLS server interfaces to a telecommunications network through a gateway, such as a message gateway. As noted above, whether a first vehicle is enabled to gain information about and/or initiate communication with a second vehicle depends on several factors. One of said factors may be the determination that said second vehicle is within a certain proximity of said second vehicle. One of said factors may be the determination that second vehicle is directly ahead of said first vehicle. One of said factors may be the determination that said second vehicle is directly behind said first vehicle. One of said factors may be the determination that said first vehicle and said second vehicle are traveling on the same road. One of said factors may be the determination that said first and second vehicles are traveling in the same general direction upon said same road. One of said factors may be the determination that no intervening vehicles are present between said first vehicle and said second vehicle upon said determined road and traveling in said determined direction. Other factors may be based upon vehicle profile information, access-preference information, and/or social networking information stored for said first vehicle and/or said second vehicle. Other of said factors may also include the user of said second vehicle authorizing information access and/or communication initiation by responding in real-time to a prompt displayed upon his or her local computing device. Said prompt to the user of said second vehicle may include, for example, a visual or audio or tactile alarm imparted by the local computing device of the second vehicle to get the second user's attention as well as a visual and/or audio prompt indicating that another vehicle has requested information access and/or requested communication initiation. The prompt may provide an indication if the vehicle that has requested information access and/or requested communication is directly ahead of OR directly behind said second vehicle. The prompt may provide an indication of the make, model, year, color, and/or license plate number of the requesting vehicle. The prompt may provide an indication of the user's name, ID, handle, or other identifier of the driver and/or owner of the requesting vehicle (i.e. the first vehicle). The prompt may also provide the user of the second vehicle with spatial information about the location of the first vehicle relative to the second vehicle. For example, a graphical map or arrow or indicator may be displayed that indicates the relative location of the first vehicle with respect to the second vehicle, depicting the relative distance and direction in which the first vehicle currently resides.

As mentioned above, the current invention enables a user of a first vehicle equipped with a local computing device to access information about and/or initiate communication with a user of a second vehicle equipped with a local computing device, subject to the relative location and direction of travel of said first and second vehicles such that one vehicle is directly ahead of said other vehicle or vice versa. To enable this inventive functionality, the present invention employs a plurality of vehicles, each equipped with a local computing device, each equipped with a positioning system such as a GPS transducer interfaced with a Navistar Global Positioning System (GPS) and an optional orientation sensor such as a magnetometer, and each having wireless access to VLS server running VLS software. In some embodiments additional sensors such as accelerometers and/or tachometers are used for detecting and/or tracking vehicle motion. Communication between each vehicle and the VLS server is generally enabled through a wireless transceiver connected to and/or integrated within each of the plurality of vehicles. In addition each local computing device of each vehicle includes a database of road information including the location and trajectory of a plurality of roads. In some such embodiments the database includes lane locations, the lane locations defining a range of locations within each road corresponding to a particular lane of that road. In some embodiments the VLS server includes and/or has access to a database of road information including the location and trajectory of a plurality of roads. In some such embodiments the database includes lane locations, the lane locations defining a range of locations within each road corresponding to a particular lane of that road.

The GPS transducer and/or other position and/or orientation transducers associated with each vehicle is operative to generate a coordinate entry that relates to the then current position (and optionally orientation and/or direction of motion of that vehicle), the coordinate entry and/or a representation thereof is communicated over the wireless communication link to the VLS server running the VLS software along with identifying information that indicates from which vehicle the coordinate entry was received. The identifying information is referred to herein as a unique vehicle identifier (UVI) as described previously. In this way the VLS server running the VLS software receives coordinate information representing the then current location (and optionally orientation and/or direction of motion) of each of a plurality of vehicles and with the UVI for that vehicle. The VLS sever stores in a locative database the current locations (an optionally the current orientation and/or direction of motion) of each vehicle. The VLS server may also store the current road on which each vehicle is traveling (and optional lane identifier for that road) of each vehicle. In this way the VLS server has up to date information about the location of each vehicle, the road it is traveling on, the direction of travel upon that road, and optionally the lane of travel upon that road. In some embodiments the VLS server may also store a current velocity for each vehicle. In some embodiments the VLS server may sort the information within the database to maintain ordering information for vehicles upon certain roads and traveling in certain directions. For example, the order of the vehicles traveling upon a certain road in a certain direction may be stored within the database by using ordering number or by linking data elements (with for example a linked list or ordered array) in a particular order that reflects the ordering of vehicles upon the road and in the particular direction. In some embodiments the ordering also reflects which lane the vehicle is traveling in. In this way the VLS server may maintain a database that includes or represents ordering information for a plurality of vehicles traveling in a certain direction, upon a certain road, and optionally in a certain lane. In addition the VLS serer maintains a unique messaging address (UMA) for each vehicle such that it can send and/or route a message to that vehicle. All such data within the VLS server is generally indexed by the vehicles unique UVI.

With respect to the transmission of positional data (including location and optional orientation and/or direction of travel) from each of a plurality of vehicles to the VLS serve, this step is repeatedly performed at a rapid rate such that said VLS server receives repeatedly updated and substantially current data about the location of said plurality of vehicles. The location information, preferably including spatial coordinates such as GPS coordinates of high resolution and accuracy, are stored in a tracking database by the VLS server. The tracking database may also store a history of the location information for each of said plurality of vehicles. The tracking database may also include predictive location information for some or all of said vehicles, said predictive location information representing an anticipated location coordinate for a vehicle as determined from current and/or historical location information and/or from velocity information for a vehicle received over the communication link from the vehicle. As for the update rate, a number of inventive methods may be employed to reduce and/or optimize the update rate for each vehicle based upon the velocity of travel of that vehicle and/or the incremental change in distance for that vehicle over time.

The present invention enables ground based vehicle users (i.e. automobile and/or truck users) to engage in vehicle to vehicle communication and/or information access through an inventive process that enables such communication even if the user initiating the communication and/or requesting the information access does not have an electronic address for the other users (i.e. does not have an address by which to address a sent message, a communication request, or an information request). For example, the present invention enables the driver of a first car to send a message to a driver of a second car even if the first user does not have a phone number, email address, text messaging address, user name, user handle, or other addressing data by which an electronic message may be addressed to the second car and/or to a user of the second car. In addition some embodiments of the present invention enables the message to be sent from the first vehicle to the second vehicle without the driver of the first vehicle (or the local computing device of his vehicle) ever having possession of a unique address for the second user, keeping the users identity and/or phone number and/or email address and/or other unique electronic address private and secure. In this way the present invention enables vehicle to vehicle communication without the user of either vehicle necessarily having a unique electronic communication address for the other vehicle (or other user) and without necessarily revealing a unique electronic communication address for the other vehicle, thereby maintaining privacy and security. Similarly, some embodiments of the present invention enables a computing device local to a first vehicle to request information about a second vehicle even if the computing device of the first vehicle (or its user) does not have a unique vehicle-specific electronic address for the second vehicle such as phone number, email address, text messaging address, user name, handle, or other addressing data by which an electronic information request may be addressed to the second car. In addition some embodiments of the present invention enables the information request to be sent from the first vehicle about the second vehicle without the driver of the first vehicle or the local computing device of the first vehicle ever having possession of a unique address for the second vehicle (or user of that vehicle), keeping such a unique address private and secure. In this way the present invention enables vehicle to vehicle information request and access without the user of either vehicle necessarily (or a computing device local to either vehicle) having a unique electronic communication address for the other vehicle (or other user) and without necessarily revealing a unique electronic communication address for the other vehicle, thereby maintaining privacy and security. In some embodiments the information accessed by a first vehicle about a second vehicle includes that vehicles make, model, year, color, current velocity, owner name, city of registration, state of registration, country of registration, and/or an owner or user specified message.

The present invention operates by enabling vehicle to vehicle communication and/or vehicle to vehicle information access based upon the relative spatial location of a first vehicle and a second vehicle at a current moment in time. More specifically, the present invention operates by enabling a computing device local to a first vehicle, as controlled and/or influenced by a user of the first vehicle, to selectively gain information about and/or send a message to a second vehicle that is driving directly in front of said first vehicle or directly behind said first vehicle. In some embodiment of the present invention, the information gained by said first vehicle from said second vehicle may include a make, model, year, color, license plate number, vehicle identification number, owner name, owner handle, owner defined message. In some embodiments of the present invention the message sent from said first vehicle to said second vehicle may include pre-scripted text message, a pre-recorded audio message, a pre-recorded video message, a real-time audio message, a real-time video message, or a non-verbal alert such as a digital honk indicator. A digital honk indicator may simply be a digital code that is received by said second vehicle and is recognized as an alert. The computer of the second vehicle may play an audible honk sound to the user(s) of the second vehicle in response to receiving a digital honk indicator.

In some embodiments the digital honk indicator may include additional information, such as identification of the vehicle which caused the alert, identification of the direction (i.e. in front, in back, to the left, to the right) of the alerting vehicle with respect to the second vehicle, and/or information about a specific type of or kind of alert. In this way a first vehicle may “honk” a second vehicle specifically, having the honk sound played within the second vehicle itself such that the users of the second vehicle can hear it but not the users of other vehicles. This allows for more specific honking alerts to be sent from one vehicle to another without distracting or confusing the users of other vehicles. In addition, the honk alert received by the second vehicle may include information about the vehicle from which the alert was sent and/or about the direction from which the alert was sent. For example, the honk alert received by the second vehicle may include make, model, color, and year information about the vehicle from which the alert was sent. This information may be displayed to the user of the second vehicle, either as textual or graphical representation, to help the user of the second vehicle visually identify the vehicle from which the alert was sent. In some embodiments the local computing device of the second vehicle accesses a database of vehicle shapes and/or images such that upon receiving information about a particular make, model, color, and year, it can render a presentation of such a vehicle by accessing the database of vehicle shapes and/or images and accessing an appropriate vehicle geometry and/or image corresponding to the received information. In this way the local computing device of the second computer may display an image of a generic version of the vehicle from which a digital honk indicator was received. The image may represent, for example, the basic shape and color of the vehicle as indicated by the received make, model, year, and color information.

In addition the digital honk indicator received by the second vehicle may include information about the relative location of the vehicle from which the alert was received. For example, the digital honk indicator may include information indicating if the vehicle that sent the digital honk indicator message is located behind the second vehicle, in front of the second vehicle, to the left of the second vehicle, or to the right of the second vehicle. In response to directional information received by the second vehicle, the local computing device may perform a spatial audio function, making the honk that is played from audio speakers within the car sound like it is coming from the direction of the car from which the alert was sent. Such a spatial audio function is sometimes referred to as a 3D audio function and would employ spatial audio methods known to the art to produce a sound through a plurality of speakers such that it sounds to the user as if it is coming from a particular direction. Thus using the methods and apparatus of the present invention a digital honk indicator message may be sent from a first vehicle that is located behind a second vehicle and in response the local computing device of the second vehicle will play a honk sound through the speakers employing a spatial audio function that makes it sound like it coming from behind the second vehicle. Similarly, using the methods and apparatus of the present invention a digital honk indicator message may be sent from a first vehicle that is located in front of a second vehicle and in response the local computing device of the second vehicle will play a honk sound through the speakers employing a spatial audio function that makes it sound like it coming from in front of the second vehicle. Similarly, using the methods and apparatus of the present invention a digital honk indicator message may be sent from a first vehicle that is located to the left of a second vehicle and in response the local computing device of the second vehicle will play a honk sound through the speakers employing a spatial audio function that makes it sound like it coming from the left of the second vehicle. Similarly, using the methods and apparatus of the present invention a digital honk indicator message may be sent from a first vehicle that is located to the right of a second vehicle and in response the local computing device of the second vehicle will play a honk sound through the speakers employing a spatial audio function that makes it sound like it coming from the right of the second vehicle. Also, it should be noted that the same spatial audio function may be employed with other forms of messages sent from said first vehicle to said second vehicle, including pre-recorded audio messages and/or real-time audio communications.

In this way a “back off” message may be sent from a first vehicle that is located in front of a second vehicle and in response the local computing device of the second vehicle will play an audio clip representing the utterance “back off” through the speakers employing a spatial audio function that makes it sound like it coming from in front of the second vehicle. Similarly a “please let me pass” message may be sent from a first vehicle that is located behind a second vehicle and in response the local computing device of the second vehicle will play an audio clip representing the utterance “please let me pass” through the speakers employing a spatial audio function that makes it sound like it coming from behind the second vehicle.

In addition to, or instead of the spatial audio function described above, the local computer of a second vehicle may display a visual indicator upon a screen (or other display surface of the second vehicle) that indicates the relative location of a first vehicle that has sent digital honk indicator or other message or information request to the second vehicle. For example, a digital honk indicator (or other message) may be sent from a first vehicle to a second vehicle and may include information indicating if the first vehicle is located behind, in front of, to the left of, or to the right of the second vehicle. In response to directional information received by the second vehicle, the local computing device may display an arrow that points in the direction of the first vehicle or otherwise graphically indicates the relative location of the first vehicle with respect to the second vehicle. In this way a user of the second vehicle can rapidly determine from where the message, honk indicator, and/or information request was sent.

In some embodiments a digital honk indicator may include information that indicates one of a plurality of standardized alert types. Example alert types may include “the light turned green”, “speed up”, “back off”, “passing on your left”, “passing on your right”, “your turn signal is on”, “your tail light is out”, “get out of the fast lane”, “requesting to pass,” and “watch out”. In this way a user of a first vehicle who is sitting behind a second vehicle that has failed to being moving when a traffic like turns from red to green may send a digital honk indicator (by making an appropriate selection of or interaction with a messaging user interface of the first vehicle) to the second vehicle, the digital honk indicator including data indicating the alert type is “the light turned green.” The digital honk indicator may also include data indicating which vehicle the alert was sent and/or from which direction the alert was sent. In response to receiving a digital honk indicator with such encoded information, the computing device of the second vehicle may play an audible honk sound to its user(s). Instead of the honk sound or in combination with the honk sound, the computing device of the second computer may play a verbal audible message “the light turned green,” indicating not just a alert from another vehicle but conveying additional information related to the type of the alert. In this way the present invention is not only better targeted at a specific vehicle than a traditional car horn, it is more informative. In some such embodiments of the present invention the local computing device of the second vehicle may include in memory a plurality of scripted messages as textual information and/or as digitized audio. For example the local computing device may include in memory a plurality of digitized audio samples—“requesting to pass”, “back off”, “your tail light is out”, “the light turned green”, and “your blinker is on”. The local computing device may select and play one of said plurality of digitized audio samples in response to a certain digital honk indicator alert type. For example, in response to receiving a digital honk indicator message of type “requesting to pass”, the local computing device of the second computer may access a digitized audio sample of a voice uttering “requesting to pass” and may play that sample through the speakers of the car. In this way the alert is not a generic honk sound but a specific audible message that corresponds with the received alert type. In some embodiments the audible message is played using spatial audio techniques as described previously.

In another example a user of a first vehicle is planning to pass a second vehicle upon a single lane highway. The user of the first vehicle sends a digital honk indicator (by making an appropriate selection of or interaction with a messaging user interface of the first vehicle) to the second vehicle, the digital honk indicator including data indicating the alert type is “passing on your left.” The digital honk indicator may also include data indicating which vehicle the alert was sent and/or from which direction the alert was sent. In response to receiving a digital honk indicator with such encoded information, the computing device of the second vehicle may play an audible honk sound to its user(s). Instead of the honk sound or in combination with the honk sound, the computing device of the second computer may play a verbal audible message “passing on your left,” indicating not just an alert from another vehicle but conveying additional valuable information related to the type of the alert. In this way the present invention is not only better targeted at a specific vehicle than a traditional car horn, it is more informative. Note—in some embodiments the played audio message may be a stored digitized audio sample as described previously. In other embodiments it may be a synthesized audio message using text-to-speech conversion techniques and/or other voice synthesis techniques known to the art. In other embodiments the audio message sample itself may be sent from the first vehicle to the second vehicle as part of the digital honk indicator data. In other embodiments only an alert code (or other alert type indicator) is sent as part of the digital honk indicator data.

For a user of a first vehicle wishing to send an alert (i.e. a digital honk indicator), send another type of message (i.e. a voice message, a text message, or a video message, whether pre-prerecorded or live), initiate bi-directional live communication (i.e. initiate a phone call or video call), or request information about a second vehicle using the methods and apparatus of the present invention, the messaging user interface of the present invention may be configured to allow the user of a first vehicle to select a target vehicle from among a plurality of possible target vehicles and send a message and/or communication request to the selected target vehicle. In some embodiments, the selection of a target vehicle includes selecting from between the vehicle directly ahead of the first vehicle and the vehicle directly behind the first vehicle. This selection may be performed by pressing an appropriate button or adjusting some other manual interface within the first vehicle, for example on the dashboard or steering wheel. This selection may be performed by issuing a voice command to a speech recognition system of the local computing device of the first vehicle. For example a simple rocker switch may be included upon the steering wheel, turn signal arm, or other inner vehicle surface or control that enables a user to indicate that a message should be sent to the vehicle in front, the vehicle behind, or both. As another example a user may utter a voice command such as “message car in front” or “message ahead” or some other similar words or phrase to indicate to the local computing device that a message should be sent to the vehicle in front of the user's vehicle. Similarly, a user may utter a voice command such as “message car behind” or “message behind” or some other similar words or phrase to indicate to the local computing device that a message should be sent to the vehicle behind the user's vehicle. In some embodiments the user may select from among more options than just ahead and behind, also optionally indicating vehicles to the side.

In one embodiment a user of a first vehicle may press a button to indicate that a real time voice message be sent to a second vehicle which is directly front of the first vehicle. Upon pressing the button a microphone within the first vehicle captures the spoken utterance of a user of the first vehicle, digitizes the utterance, and sends the utterance as a digital message to the second vehicle. The digitized utterance may be sent with additional information, for example indicating from which vehicle the message was sent, from which direction the vehicle was sent, the make and/or model and/or color and/or year of the vehicle from which the message was sent, and/or other information such as the license plate number, VIN number, UVI, UMA, or other identifying information about the first vehicle or a user of the first vehicle.

Thus a variety of messaging user interface methods may be used to enable a user of a first vehicle to select a second vehicle from among a plurality of possible vehicles based upon the relative spatial location of the second vehicle with respect to the first vehicle. In addition a variety of messaging user interface methods may be used to enable a user of a first vehicle to select from among a plurality of message types, honk indicator alert types, communication initiation request types, and/or information access request types to be sent to a second vehicle. Upon a user of a first vehicle selecting a target vehicle and/or selecting a message type and/or honk indicator alert type and/or communication request type and/or information access request type, the local computing device of the first vehicle may gain information about and/or send a message to the second vehicle using the methods and apparatus as described herein. For example, a user of a first vehicle who is being tailgated by a user of second vehicle may send a digital message to the user of the second vehicle requesting that the user stop tailgating. Similarly a user of a first vehicle, who is planning to pass a second vehicle in front of him or her, may send a digital message to the user of the second vehicle informing the second vehicle user of the first vehicle user's intent to pass. In this way the unique addressing and messaging methods provided by the present invention enable users to selectively communicate alerts, intentions, greetings, concerns, and/or apologies between them, making driving a more social and interactive experience between users of proximate vehicles.

As used herein, “local computing device” should be broadly construed as including any mobile wireless client device that is associated with said vehicle and moves with said vehicle. A typical local computing device is a wireless access protocol (WAP)-enabled device that is capable of sending and receiving data in a wireless manner using the wireless application protocol. The wireless application protocol (“WAP”) may support wireless networks, including CDPD, CDMA, GSM, PDC, PHS, TDMA, FLEX, ReFLEX, iDEN, TETRA, DECT, DataTAC, and Mobitex, and it operates with many operating systems. Typically, WAP-enabled devices use graphical displays and can access the Internet (or other communication network) on so-called mini- or micro-browsers, which are web browsers with small file sizes that can accommodate the reduced memory constraints of portable devices and the low-bandwidth constraints of a wireless networks. In one embodiment, the local computing device communicates over a cellular network, for example a GSM networks. The local computing device, which may include telephone capabilities, video phone capabilities, email capabilities, text messaging capabilities, and other common communication capabilities, can communicate using one or more communication methods, for example SMS (short message service), enhanced SMS (EMS), multi-media message (MMS), email WAP, paging, or other known or later-developed wireless data formats. The present invention is not limited to WAP-enabled computing devices or to use of any particular type of wireless network. Such devices and networks are merely illustrative; any wireless data communication technology now known or hereafter developed may be used in connection with the invention that is now described in more detail.

The present invention operates by including one or more locative sensors within each enabled vehicle, the locative sensor providing data indicating the spatial location and direction of travel of the vehicle at a current moment in time. The locative sensors may include, for example, a GPS transducer that provides geospatial coordinates for the vehicle at a current moment in time. For example, a second generation GPS system created by the European Union is expected to soon provide GPS positional data to appropriately equipped transducers with a spatial accuracy of 1 meter or less. The locative sensor may be supplemented by additional information, such as vehicle relative travel information based upon wheel speed and car travel direction. The locative sensor may also include an orientational sensor, such as a magnetometer, for determining the heading direction of the vehicles travel. The system may also cross reference a database of known roads to increase the accuracy of locative determinations based upon sensor readings. The locative sensors may also receive information from land-based beacon reference points that increase the accuracy of positional determinations.

With respect to prior art systems that track spatial locations using GPS and access information based upon GPS locations, a number of systems have been developed. Some early systems are described in the paper by Spohrer entitled Information in Places and published in IBM Systems Journal, vol. 38, No. 4, 1999 (p. 602-628) which is hereby incorporated by reference. Other systems are described in U.S. Pat. Nos. 6,122,520 and 6,819,267 and U.S. Patent Publication No. 2005/0032528, now issued U.S. Pat. No. 6,983,139, which are all hereby incorporated by reference. While such systems enable a user to gain information about their current spatial location in the physical world based upon captured GPS data, such systems do not enable a user of one moving vehicle to initiate communication with and/or gain information about another moving vehicle based upon their relative locations.

Another technology known to the current art that tracks spatial locations is referred to herein as mobile social networking systems. One such application known as Dodgeball can identify the location of the user and the friend of a user and alert the user when the friend is within certain proximity. Another system disclosed in pending U.S. Patent Publication No. 2005/0177614, which is also incorporated by reference, enables like-minded mobile device users to meet one another, on a permission basis, based upon one or more factors, such as each user's reciprocal networking objective, the nature of the industry in which the user works, the user's level within the management hierarchy of his or her company, any specialty function the individual may possess, and so on. While such systems alert a user to friends and/or coworkers who are within certain proximity of the user, such systems do not enable the features and functions of the present invention. For example, such systems do not enable a user of one moving vehicle to selectively initiate communication with and/or gain information about another moving vehicle based upon the relative locations of the vehicles. Furthermore such systems do not enable a user of a first vehicle to select a second vehicle from among a plurality of vehicles within proximity the first vehicle and then initiate communication with and/or access information related to said second vehicle. Furthermore such systems do not enable digital honk indicators and or other message types disclosed herein. Furthermore such systems do not enable audio messages displayed through spatial audio techniques as disclosed herein. Furthermore such systems do not enable the many vehicle specific methods and apparatus disclosed herein.

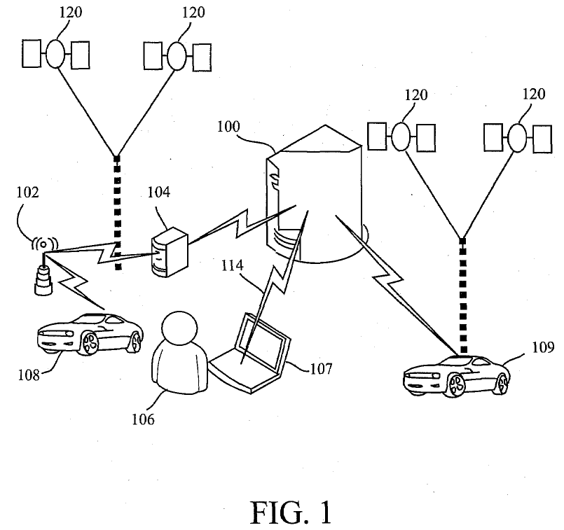

With respect to the architecture of the present invention, we may refer by example to a sample embodiment shown in FIG. 1. As illustrated in FIG. 1, the present invention may be implemented as a managed service (e.g., in an ASP model) using a VLS server 100, which is connected or connectable to one or more networks. For illustrated purposes, the VLS server 100 is illustrated as a single machine, but one of ordinary skill will appreciate that this is not a limitation of the invention. More generally, the service is provided by an operator using a set of one or more computing-related entities (systems, machines, processes, programs, libraries, functions, or the like) that together facilitate or provide the inventive functionality described below. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment. As illustrated FIG. 1, the VLS server 100 is also in communication with a mobile service provider through a gateway, such as gateway 104. Thus the VLS server may communicate with the local computing device of one or more vehicles through a cellular network and/or other network, for example an internet based network.

As also illustrated in FIG. 1, one or more users 106 may register for the service, typically by using a client machine which may be the portable computing device 111 or some other machines such as a desktop computer. It may also be a local computing device to a vehicle such as vehicle 108 or vehicle 109. When a desktop computer is used, registration is generally initiated by an end user opening a Web browser to the operator's Web site registration page (or set of registration pages). When a portable computing device is used, registration may be initiating through a mini-browser or other similar interface. These techniques are merely representative, as any convenient technique (including, without limitation, email, filling out and mailing forms, and the like) may be used. Thus, in the illustrated embodiment, users may be required to register themselves and/or register their vehicles with the VLS server 100 (or set of servers) either through Internet connections from personal computers, or via remote registration through a mobile device. The registration process may include entering information about their vehicle including one or more of a VIN number, a license plate number, a make, a model, a year, a color, a unique message address, a vehicle specific password, a registration location, an owner name, a home address for the owner, a mobile phone number for an owner or driver, and an email address for an owner or driver.

Also illustrated in FIG. 1 is a Global Positioning System (GPS) 120 for use in tracking the location of vehicles such as vehicle 108 and vehicle 109. Each of said vehicles includes a local computing device that receives data from a GPS transceiver within the vehicle. The local computing device may be a single processor or a plurality of connected processors within said vehicle. The local computing device includes a messaging user interface by which a user of the vehicle may enter information and/or make selections that influence routines running upon said local computing device. Global Positioning System (GPS) technology provides latitudinal and longitudinal information on the surface of the earth. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the invention. However, other positioning systems are also contemplated for use with the present invention, for example, the next generation GPS system launched by the European Space Agency.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In order to gain orientation information about a vehicle, one or more sensors may be included within or affixed to the vehicles. For example a magnetometer may be employed to provide orientation information with respect to magnetic north. Alternately orientation information may be inferred based upon two or more subsequent readings of positioning sensors such as GPS. In some embodiments a plurality of GPS transducers may be employed at different locations within the vehicle to derive orientation information. When sensors are employed they are generally connected directly or through a network or other data communication channel to the local computing device of the vehicle.

In order to gain direction of motion information about a vehicle, a plurality of subsequent GPS readings may be gathered over time and used to determine a direction of motion of the vehicle over that period of time. In some embodiments sensors may be employed to determine direction of motion information. For example an accelerometer may be included to provide motion information about the vehicle. In some embodiments a magnetometer may be employed to provide directional information about the vehicle. In some embodiments magnetometer data is used in combination with vehicle tachometer data to determine direction of motion. When sensors are employed they are generally connected directly or through a network or other data communication channel to the local computing device of the vehicle.

In order to gain vehicle speed information about a vehicle, a plurality of subsequent GPS readings may be gathered over time and used to determine a speed of motion of the vehicle over that period of time. In some embodiments sensors may be employed to determine speed information. For example a vehicle tachometer may be used to determine speed information. When speed sensors are employed they are generally connected directly or through a network or other data communication channel to the local computing device of the vehicle.

Thus as shown in FIG. 1, a plurality of vehicles (108 and 109) are equipped such that each vehicle has a locative sensor (such as a GPS sensor responsive to GPS satellites 120) and a wireless communication link to a VLS server (100). Each vehicle has a local computing device and/or sensors that can compute or otherwise derive a direction of travel for the vehicle. In some embodiments the VLS server may determine the direction of travel in stead of, or in addition to, the determination made by the local computing device. Each vehicle is configured through software upon its local computing device to report locative data to said VLS server repeatedly when actively using the present invention. In some embodiments the local computing device of each vehicle is configured to send locative information including current GPS location information and direction of travel information at regular time intervals to the VLS server. In some embodiments the local computing device of each vehicle is configured to send locative information including current GPS location information and direction of travel information to the VLS server at a time interval that is dependent upon the vehicles velocity (in general the time interval is less when the velocity is greater). In some embodiments the local computing device of each vehicle is configured to send locative information including current GPS location information and direction of travel information to the VLS server each time the vehicle has moved a certain distance. By making the locative information update rate dependent upon vehicle velocity and/or upon incremental vehicle displacement, a vehicle sitting at a stop light need not update its location information as quickly as a vehicle traveling quickly upon a freeway. Similarly a slow moving vehicle need not update its location information as quickly as a fast moving vehicle. Such methods save communication bandwidth to the VLS server.

The VLS server, as described previously, maintains a locative database of vehicles that are currently using the service. The locative database may be maintained upon the same machine that runs the VLS application or may be accessed from a separate machine over a communication network. Thus locative server, alone or in combination with other computing machines, is operative to maintain a database of a plurality of currently active vehicles, each indexed by a unique identifier, the database including a substantially current location and substantially current direction of travel for each. The current location may be, for example, a current GPS location for the vehicle. The current direction of travel may be, for example, an orientation of the travel direction of the vehicle such as north-west or east. In some embodiments the unique identifier used by the database is the same as or a derivative of the UVI for that vehicle. The database may also include a unique messaging address (UMA), for example a phone number, URL, or other addressing means by which digital communications can be uniquely directed to that particular vehicle. In some embodiments the UMA and the UVA are the same. In some embodiments the UMA and UVA are different but relationally associated by said database.

In some embodiments the current location information stored by the VLS sever (100) includes current road location information for each vehicle that identifies the road (i.e. road, street, avenue, highway, freeway, or other naming convention for a road accessible by ground vehicles) upon which that vehicle is currently traveling. The current road location information may also include a locative identifier as to where upon the length of the road the vehicle currently is. In some embodiments the current road information may also include the lane of the road that the vehicle is currently in. The current road information may also include the direction of travel that the vehicle is currently traveling upon the road, for example northbound, southbound, eastbound, or westbound. In this way a the current road information for a vehicle may identify the current road the vehicle is on, the current lane of the road, the current direction of travel upon the road, and/or the current location upon the length of the road that the vehicle is currently located at. The current road information may be stored in addition to current location and current direction of travel mentioned earlier OR may be stored instead of the current location and current direction of travel information.

By current location, current direction of travel, and current road location information it is understood that there will generally be some amount time lag that causes the locative data stored for some or all vehicles to reflect that vehicle's location and/or direction of travel at a recent time in the past. It is therefore desirable for the current invention to keep such time lags as small as possible within the practical limitations of the technology employed. It is also often desirable for the locative server to store a time-history of current locations for said plurality of vehicles, said time-history reflecting one or more previous but recent locations of each of said plurality of vehicles. It is also sometimes desirable for the locative server to store a current speed for each of said plurality of vehicles, said current speed being derived from speed data received from each vehicle, being derived from said time history of current locations for each vehicle, or a combination of both. Furthermore, in some embodiments of the present invention the VLS application running on the VLS server (100) may be operative to predict a more current location of a vehicle based at least in part upon the recent stored time-history of previous locations of that vehicle and/or a most recent speed of the vehicle and/or a most recent direction of travel of the vehicle.

It should be noted that the current road location information may be determined for each vehicle by the VLS server by cross referencing a GPS location for that vehicle (or other spatial location coordinate) with a stored map database of road locations accessible to the server. In this way the VLS server, receiving locative coordinates for each vehicle, may determine the current road location information for that vehicle. In some embodiments the current road location information for a particular vehicle may be determined by the local computing device of that vehicle by cross referencing a GPS location for that vehicle (or other spatial location coordinate) with a stored map database of road locations accessible to the local computing device. In such embodiments the local computing device of a vehicle may communicate some or all of the current road location information about that vehicle to the VLS server over the wireless communication link.

In addition to tracking the current location of a plurality of vehicles, each using a portable computing device, the VLS server (and/or related computing device) may be operative to store a unique vehicle profile for each of said plurality of vehicles, the unique vehicle profile including information such as the make, model, year, exterior paint color, city or state or country of ownership of the vehicle, owner name or identifier, owner address, or other similar information for each vehicle. The VLS application may also be operative to store access-preference information for each vehicle, the access-preference information describing and/or limiting how other users (or vehicles) may gain information about that vehicle and/or initiate communication with the vehicle. For example, access-preference information may limit access to some or all information only to other users or vehicles who match certain criteria, possess certain characteristics, and/or meet certain security requirements. For example, certain information may be defined as access-restricted such that it may only be accessed by police (or other law enforcement) users and/or by police (or other law enforcement) vehicles. Similarly, access-preference information may limit communication with a particular user (or vehicles) only to those who match certain criteria, possess certain characteristics, and/or meet certain security requirements. In some embodiments said certain security requirements includes a particular user possessing a password or satisfying some other authentication requirement such as belonging to an official government, police, or law enforcement organization. In some embodiments said certain criteria includes a particular user being a member of a particular social network or business organization or subscription service.

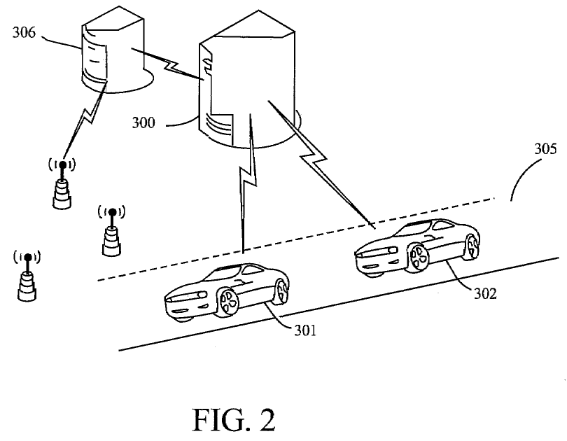

Referring next to FIG. 2, shown is another embodiment of the present invention including a plurality of vehicles (301) and (302), a VLS server (300) running a VLS application, and a wireless communication link between the VLS server and the plurality of vehicles. Not shown are the specific locative sensor technologies (such as GPS satellites and transceivers). Also, a variety of wireless communication methods may be employed to communicate with the vehicles, including for example wi-fi networks, cellular networks, or other communication networks that may not yet be known to the art.

As shown in the figure, the VLS server (300) is accessed by a plurality of vehicles (301) and (302), each of said vehicles employing a local computing device with wireless communication capability and spatial location tracking capability. The methods and apparatus as disclosed herein enable the local computing device of a first vehicle (for example 302) to access information about and/or initiate communication with a second vehicle (for example 301) based in whole or in part upon the relative location of said second vehicle with respect to said first vehicle. More specifically, the methods and apparatus as disclosed herein enable the local computing device of a first vehicle to access information and/or initiate communication through a local computing device of a second vehicle based upon input from a user of said first vehicle and a determination by said locative server that said second vehicle is located directly ahead of said first vehicle upon a particular road on which both said first and second vehicles are traveling. Similarly, the methods and apparatus as disclosed herein enable the local computing device of a first vehicle to access information and/or initiate communication through a local computing device of a second vehicle based upon input from a user of said first vehicle and a determination by said locative server that said second vehicle is located directly behind said first vehicle upon a particular road on which both said first and second vehicles are traveling. In addition the methods of the present invention enable a user of said first vehicle of enter input to said local computing device of said first vehicle to specify if said computing device of said first vehicle should access information about and/or initiate communication with a second vehicle that is located directly in front of said first vehicle or directly behind said first vehicle.

The determination of whether a first vehicle accesses information about a second vehicle and/or the determination of whether a first vehicle initiates communication with a second vehicle and/or the determination of whether a first vehicle sends a message to a second vehicle depends at least in part upon the relative location of said second vehicle with respect to said first vehicle. More specifically the determination of whether a first vehicle accesses information about a second vehicle may depend upon a determination by said locative server that said second vehicle is located directly in front of said first vehicle with no intervening vehicles between them OR a determination by the locative server that said second vehicle is located directly behind said first vehicle with no intervening vehicles between them. Note—in some embodiments the system also supports determinations that a second vehicle is directly to the right of a first vehicle OR a determination that a second vehicle is directly to the left of a first vehicle although the examples given herein will focus upon ahead and behind.

The determination that a second vehicle is “directly in front” a first vehicle and/or the determination that a second vehicle is “directly behind” a first vehicle may be performed by said VLS server performing a number of assessments as follows:

Same Road Assessment: The VLS server determines if a first vehicle (for example 301) and a second vehicle (for example 302) are traveling upon the same road (for example 305) based upon the current locative data for said first vehicle as correlated with a database of road locations AND based upon the current locative data for said second vehicle as correlated with said database of road locations. More specifically, the road that said first vehicle is on is determined based upon the current locative data for said first vehicle as correlated with a database of mapped road locations. In addition the road that said second vehicle is upon is determined based upon the current locative data for said second vehicle as correlated with said database of mapped road locations. The road that each of said first vehicle and said second vehicle is currently on is then compared to asses if they are on the same road. For example, if vehicle 301 is determined to be on road 305 and vehicle 302 is determined to be on road 305, then it may be determined that vehicle 301 and vehicle 302 are on the same road.

Same Direction Assessment: The VLS server determines if said first vehicle (for example 301) and said second vehicle (for example 302) are traveling in the same general direction upon a given road (i.e. northbound, southbound, eastbound, or westbound) based upon the current orientation data and/or direction of travel data for said first vehicle and the current orientation data for said second vehicle. If the current orientation data and/or direction of travel data for said first vehicle is the same (or substantially similar) to the current orientation data and/or direction of travel data for said second vehicle (i.e. if the two are within a certain angular threshold of each other), the VLS server will determine that the vehicles are traveling in the same general direction. For two vehicles traveling on a road that is very bendy, this purely directional method may fail because the road changes direction often within a short distance. To account for this situation, other methods may be used to determine that two vehicles are traveling in the same general direction upon a particular road. For example a number of data points that represent a history of positional values for said first vehicle may be assessed to determine an average general direction over a period of time (for example 20 seconds). Similarly a number of data points that represent a history of positional values for said second vehicle may be assessed to determine an average general direction over said period of time. If the general direction assessment for said first vehicle is similar (i.e. within a certain threshold of ) the general direction of travel assessment for said second vehicle, the VLS server may determine that said first and second vehicles are traveling in the same direction.

Alternately a road direction of travel may be determined for a vehicle based upon the mapping data for the road that the vehicle is currently traveling upon. The road direction of travel may be determined based upon the lane location of the vehicle on the road (i.e. is the vehicle on a northbound lane or a southbound lane) and/or based upon orientation data for said vehicle with respect to mapping data for said road and/or based upon a history of travel locations of said vehicle with respect to mapping data for said road. In this way a determination of a road travel direction upon the road may be determined for a vehicle (i.e. is the vehicle traveling in the northbound or southbound direction upon a road that has those travel directions associated with it OR if the vehicle traveling in the eastbound or westbound direction upon a road that has those travel directions associated with it). In general when road information is correlated with orientation information and/or direction of travel information for a vehicle, the road direction information is easy to assess because a given road generally has only two possibilities for road travel direction (i.e. northbound or southbound).

Same Lane Assessment: Similar to the same road assessment, the VLS server may be configured to determine if said first and second vehicle are traveling in the same lane of same road based upon the current locative data for said first vehicle as correlated with a road mapping database that includes road lane locations AND based upon the current locative data for said second vehicle as correlated with said road mapping database that includes road lane locations. More specifically, the road and lane that said first vehicle is traveling upon is determined based upon the current locative data for said first vehicle as correlated with said database of road and lane locations. In addition the road and lane that said second vehicle is upon is determined based upon the current locative data for said second vehicle as correlated with said database of road and lane locations. If the road and lane of the first vehicle is the same as the road and lane of the second vehicle, the two vehicles are determined to be in the same lane. Note—in some embodiments multiple assessments are made over a time history of locations for said first and second vehicles to get a more accurate assessment of current road and current lane.

Directly Ahead Assessment: Once it is determined that a first and second vehicle are traveling (a) upon the same road, (b) in the same direction of travel upon the road, (c) in the same lane (if the road has multiple lanes in the current direction of travel), and (d) are within some minimum proximity of each other, the VLS server may then determine if the second vehicle is directly ahead of said first vehicle by determining (1) that the second vehicle is ahead of said first vehicle by virtue of its location being forward of said first vehicle along the direction of travel that said first and second vehicles are moving on the road they are traveling upon and (2) that there are no intervening vehicles upon the same road, upon the same lane, and traveling in the same direction, between said first vehicle and said second vehicle. Said another way, the VLS server may be configured to find the vehicle that is of closest proximity to said first vehicle that is (a) traveling upon the same road, (b) traveling in the same lane, (c) traveling in the same direction as the first vehicle, and (d) is ahead of said first vehicle in the direction of travel of said first vehicle.

Directly Behind Assessment: Once it is determined that a first and second vehicle are traveling (a) upon the same road, (b) in the same direction of travel upon that road, (c) in the same lane (if the road has multiple lanes in the current direction), and (d) are within some minimum proximity of each other, the VLS server may then determine if the second vehicle is directly behind said first vehicle by determining (1) that the second vehicle is behind said first vehicle by virtue of its location being behind said first vehicle along the direction of travel that said first and second vehicles are moving on the road they are traveling upon and (2) that there are no intervening vehicles upon the same road, upon the same lane, and traveling in the same direction, between said first vehicle and said second vehicle. Said another way, the VLS server may be configured to find the vehicle that is of closest proximity to said first vehicle that is (a) traveling upon the same road, (b) traveling in the same lane, (c) traveling in the same general direction as the first vehicle, and (d) is behind said first vehicle in the direction of travel of said first vehicle.

In some embodiments of the present invention, the assessments described above are performed by the VLS server for all vehicles that are within certain proximity of said first vehicle when said first vehicle requests information about a second vehicle and/or requests to send a message to a second vehicle. More specifically, the user of said first vehicle may request to send a message to the vehicle that is directly ahead. The VLS server receives this request and must determine which vehicle of the plurality of vehicles being tracked by the VLS server is the one that is currently directly ahead of said first vehicle. To perform this function, the VLS server may perform the above assessments upon a plurality of vehicles with respect to said first vehicle to find that vehicle which is identified as being directly ahead of said first vehicle. The plurality of vehicles chosen may be all vehicles within a certain proximity of said first vehicle—for example, within 100 feet. Alternately the plurality of vehicles may be chosen as the N closest vehicles to said first vehicle based upon linear distance. Alternately the plurality of vehicles may be chosen as those vehicles that are currently determined to be on the same road as the first vehicle and within a certain proximity of the first vehicle. Alternately the plurality of vehicles may be chosen as the N closest vehicles to said first vehicle that are currently upon the same road as said first vehicle, are currently traveling in the same direction as the first vehicle, and are within a certain proximity of the first vehicle.

In some embodiments of the present invention, the VLS server determines the road of travel and the road direction of travel upon the road of travel for all vehicles within the database, updating those values regularly. This speeds the assessment process when a particular vehicle is to be found that is directly ahead of or directly behind a first vehicle. Note—in general the VLS server may be comprised of a plurality of computers, each computer handling a subset of the vehicles currently active using the inventive service. For example, each of a plurality of computers (or sets of computers) can be configured to handle the processing required for vehicles in different local geographic regions.

In a preferred embodiment, when a user of a first vehicle (for example vehicle 302) requests that information be accessed about and/or a message be sent to the vehicle directly ahead of the first vehicle (for example vehicle 301), the VLS server finds this vehicle by determining based upon the most currently received data the closest vehicle to the first vehicle that is (a) traveling upon the same road as the first vehicle, (b) traveling in the same direction as the first vehicle, (c) is in the same road lane of said first vehicle (if the road has a plurality of lanes in the direction of travel), and (d) is ahead of the said first vehicle along the direction of travel of said first vehicle is moving upon the road that said first vehicle is traveling upon. Similarly, when a user of a first vehicle requests that information be accessed about and/or a message be sent to the vehicle directly behind the first vehicle, the VLS server finds this vehicle by determining the closest vehicle to the first vehicle that is (a) traveling upon the same road as the first vehicle, (b) traveling in the same direction as the first vehicle, (c) is in the same road lane of said first vehicle (if the road has a plurality of lanes in the direction of travel), and (d) is behind the said first vehicle in the direction of travel of said first vehicle is moving upon the road that said first vehicle is traveling upon. In this way the VLS server may determine based upon stored current location information (and optionally stored current orientation information) which vehicle is likely to be the one that is current directly ahead of OR directly behind the first vehicle. Note—the current system works best if all vehicles in the proximity of the first vehicle are being tracked by the VLS server.

Note, in some embodiments of the present invention the first vehicle may include a ranging technology upon the front or back of the vehicle to determine a distance to the vehicle directly ahead and/or the vehicle directly behind. The ranging technology may be, for example, laser range finder technology and/or ultrasonic ranging technology and/or radar technology. The ranging data may be used to facilitate the determination made by the VLS server as to which vehicle is the one directly ahead and/or directly behind the first vehicle. In such embodiments the first vehicle local computing device communicates the ranging information to the VLS server. The VLS server may then use this data in determining which vehicle is directly ahead or behind. For example, if the ranging sensor determines that the vehicle directly ahead is 56 feet ahead of the first vehicle, the VLS sever needs only to add an offset to the current location of the first vehicle approximately equal to 56 feet ahead in the direction of travel of the first vehicle to find the spatial location of the vehicle that is directly ahead of the first vehicle. The VLS server may then access the database to find what vehicle is currently closest to that location and identify that vehicle as the vehicle directly ahead of the first vehicle. In some such embodiments the VLS server may access the database to find what vehicle is (a) traveling on the same road as the first vehicle, (b) traveling in the same lane as the first vehicle, (c) traveling in the same direction as the first vehicle, AND is closest to the location determined by adding the ranging offset (as determined by the ranging sensor on the first vehicle) to the current location of the first vehicle. The same process may be used using a backward facing ranging sensor in finding the vehicle directly behind the first vehicle.

Once the VLS server determines a vehicle that is directly ahead of said first vehicle and/or determines a vehicle that is directly behind said first vehicle, the VLS server may enable the local computing device of the first vehicle to gain information about said second vehicle and/or initiate communication with said second vehicle.

In some embodiments the VLS server enables said local computing device of said first vehicle to gain information about said second vehicle by sending the data directly from the VLS server to said local computing device of said first vehicle. In such embodiments the VLS server may maintain within its database, some or all of the information that a third party may desire to access about each vehicle. For example, the VLS server may maintain information in its database about the make, model, year, color, owner name, current speed, current location, even current driver name within its database and sends some or all of that data to vehicles that request such information (i.e. the first vehicle in this example). In some embodiments the information that the VLS server sends to the first vehicle about the second vehicle may be dependent upon privacy and/or security parameters and/or social networking information and/or access parameters stored for said second vehicle in said database. In some embodiments the information that the VLS server sends to the first vehicle may also be dependent upon privacy parameters and/or security parameters and/or social networking information stored for said first vehicle within said database. For example, if the first vehicle is a registered police vehicle and has certain security access parameter associated with it, more detailed information stored in the database for the second vehicle may be transferred to the first vehicle than if the first vehicle was a privately owned vehicle without special access privileges.

In some embodiments, when a first vehicle requests information about a second vehicle, the VLS server sends data to the second vehicle, prompting a user of the second vehicle to approve or deny the request. In such embodiments the accessing of information by said first vehicle about said second vehicle is dependent upon a user of said second vehicle providing an approval of said request. The approval is generally transmitted from said second vehicle back to said VLS server. The VLS server upon receiving an approval from said second vehicle may then communicate the requested information (or a portion thereof) to said first vehicle. In some embodiments the approval may include information such as a level or degree of approval, the level or degree of approval affecting the amount of information sent by the VLS server about the second vehicle to the first vehicle.

In some embodiments the VLS server enables the local computing device of said first vehicle to send a message to and/or initiate bi-directional communication with said second vehicle by routing information back and forth between said first vehicle and said second vehicle. To support such embodiment the VLS server may maintain within its database, communication addressing information about each of said vehicles. In this way the VLS server may relay a message from said first vehicle and/or route communications from said first vehicle to said second vehicle using a stored communication address for said second vehicle accessed from said database. Similarly the VLS server may relay a message from said second vehicle and/or route communications from said second vehicle to said first vehicle using a stored communication address for said first vehicle accessed from said database. In this way the VLS server may enable communication between said first and second vehicle without revealing the addressing information about either vehicle to the other vehicle, maintaining anonymity between vehicles (and users of vehicles). This ability for the VLS server to route messages and/or communications between said first vehicle and said second vehicle is a great benefit in some embodiments because it enables communications to be established between users of vehicles that come within proximity of each other without revealing any personal information and/or permanent addressing information of each vehicle (or user) to the other vehicle (or user). In other embodiments the VLS server may be operative to convey unique vehicle addressing information for said second vehicle to said first vehicle, and vice versa, enabling the two vehicles to communicate directly through an intervening communication network. In some embodiments both the anonymous communication method (achieved with the VLS server acting as the intermediary for routing information between vehicles) and the direct communication method (achieved by the VLS server passing vehicle communication addressing information about one vehicle to another) may be selectively enabled depending upon the situation at hand.

Some embodiments of the present invention enable each vehicle to report its current speed to the VLS server along with its current positional coordinates during some or all updates. The speed reports may be used by the VLS server in some embodiments to account for time-lag by providing through an inventive Predictive Tracking Algorithm in which a more accurate current location of a vehicle is predicted by the VLS server based upon its reported current location (which is subject to time lag) and the reported current speed and direction of travel. The Predictive Tracking Algorithm computes the more accurate current location of a portable computing device by adding a predictive spatial offset to the reported current location of that vehicle, the predictive spatial offset being computed based upon the reported speed (and direction of travel) and a known or estimated time lag between the reported location and the current time. For example, if a vehicle reports its current location is POSITION A upon a certain road and if the vehicle reports its current speed is B MILES PER HOUR and the vehicle is traveling in a NORTHBOUND direction upon said certain road and if it is known (or estimated) that a (t) second time lag is present between the time when the data was collected and the current time the data is being processed by the VLS server, a more accurate current location can be predicted by adding an offset to POSITION A equal to the estimated distance the vehicle traveled in the NORTHBOUND direction upon the certain road assuming the speed remained B MILES PER HOUR during the time lag period. In this way a new POSITION A′ may be determined that is an OFFSET DISTANCE ahead of POSITION A in the NORTHBOUND direction upon the certain road. The OFFSET DISTANCE may be computed in any units. For example, if miles are used, the OFFSET DISTANCE will equal B MILES PER HOUR multiplied by the time lag (t) in second divided by 3600 seconds per hour. Thus:

OFFSET DISTANCE=B MILES PER HOUR*(t)seconds/3600

Under such a model the predicted position of the vehicle is POSITION A′, this position being POSITION A with an offset added equal to the OFFSET DISTANCE along the road in the direction of travel (which in this example was NORTHBOUND). In other examples the direction of travel might be, for example, SOUTHBOUND in which case the offset is added in that road direction.

To support accurate time lag computations or estimations, some embodiments of the present invention enable local computing devices of each vehicle to also report a time-stamp value to the VLS server along with the report of current positional coordinates. The time-stamp value indicates or otherwise represents the time at which the current positional coordinate was collected. This value is then used by the VLS sever to determine the time lag between when the most recently current positional coordinate was reported from a given vehicle and the then current time at which a tracking determination is being computed. In this way the VLS server can know how up to date each positional coordinate is when performing a tracking determination of the relative location of two or more vehicles. In this way the VLS server can also more effectively account for time-lag using a predictive algorithm such as the one described above.

Thus, some embodiments of the present invention are configured such that each portable computing device reports to the VLS server its most current positional coordinates, its most current speed measurement or estimation, a time-stamp indicating when the positional coordinates were collected, and unique identifier enabling the VLS server to correlated the received data with a particular vehicle. Some or all of this data is then stored in a tracking database for the plurality of vehicles. In some embodiments in which the local computing device of a vehicle does not report a time stamp, the VLS server may be configured to store its own time-stamp for data received, the VLS server time-stamp indicating the time at which a current positional coordinate was received from a vehicle. Such a time-stamp is generally not as accurate as one generated by a local computing device of a vehicle itself for there may be communication and processing delay that is not accounted for, but using this method reduces the amount of information that need be communicated over the communication link and therefore helps preserve communication bandwidth.

In some embodiments of the present invention the VLS server also stores a time-history of current locations for said plurality of vehicles, said time-history reflecting one or more previous but recent locations of each of said plurality of vehicles. Furthermore, in some embodiments of the present invention the VLS application running on the VLS server may be operative to predict a current location of a vehicle based at least in part upon the stored time-history of previous locations of that vehicle, for example by deriving a speed for that vehicle from the stored time-history of previous locations of that vehicle and computing an offset based upon the derived speed and a known or estimated time lag (using a method such as the one described above).

In some embodiments the VLS server may communicate locative information to a second vehicle indicating the relative location of a first vehicle. This information may be communicated as a vehicle locative vector that points in the direction from said second vehicle to said first vehicle. To derive the directional vector sent to the second vehicle, the VLS server may perform a simple vector subtraction of the current location of the second vehicle minus the current location of the first vehicle. This vehicle locative vector may be displayed upon a screen of said second vehicle as a graphical arrow or other indicator that points in the direction of the first vehicle. In this way if a second vehicle is targeted by a first vehicle for requested communication and/or messaging and/or information access, the user of the second vehicle may be provided with a graphical indicator as to the direction from which the request was sent.

Thus as described previously, some embodiments may require that a user of a second vehicle provide authorization before a first vehicle accesses information and/or sends a message and/or initiates bi-directional communication. Such embodiments often involve a user of a second vehicle being prompted for authorization and/or approval. Said prompt to the user of said second vehicle may include, for example, a visual or audio or tactile alert imparted by the local computing device of the second vehicle to get the second user's attention as well as a visual and/or audio prompt indicating that another vehicle has requested information access and/or requested communication initiation. The prompt may provide an indication of the direction of the requesting vehicle. For example, the prompt may include an indicator as to whether the vehicle that has requested information access and/or requested communication is directly ahead of OR directly behind said second vehicle. The prompt may provide an indication of the make, model, year, color, and/or license plate number of the requesting vehicle. The prompt may provide an indication of the user's name, ID, handle, or other identifier of the driver and/or owner of the requesting vehicle (i.e. the first vehicle). The prompt may also provide the user of the second vehicle with spatial information about the location of the first vehicle relative to the second vehicle. For example, a graphical map or arrow or indicator may be displayed that indicates the relative location of the first vehicle with respect to the second vehicle, depicting the relative distance and direction in which the first vehicle currently resides. This graphical indicator may be rendered based upon a received vehicle locative vector as described above.

In some embodiments of the present invention, when a first user requests information access and/or communication with a second vehicle, a first step in the vehicle to vehicle communication process is a vehicle make and/or model and/or color being accessed and displayed to first user about the second vehicle. The first user may review the vehicle make and/or model and/or color and thereby confirm if the server located the intended vehicle. For example, if a user requests that a message be sent to the vehicle in front of his or her vehicle, the make and model and color accessed by a server may be reviewed by the first user prior to sending the message as a confirmation that the correct vehicle was identified by the server.

It should be noted that in certain embodiments of the present invention, the local computing device on a first vehicle may act as a locative server or part of a locative server, communicating directly by wireless link with a plurality of other vehicles within certain proximity of the first vehicle and thereby performing some or all of the features and functions of the present invention. In some such embodiments locative data and/or vehicle identifying data may be communicated directly between said first vehicle to one or more other vehicles. In some such embodiments a plurality of locative servers may be active, each upon one of a plurality of vehicles. In some embodiments the features and functions performed by the locative server may be shared among a plurality of computers, said computers including one or more local computing devices.

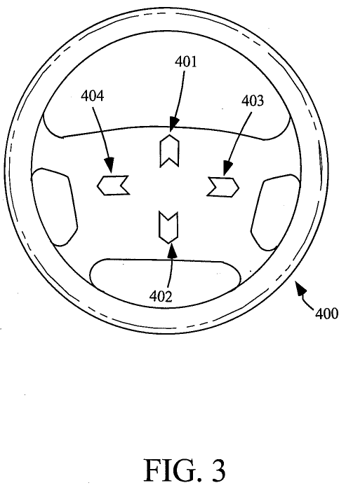

Referring next to FIG. 3 is one example messaging user interface of the present invention in which a plurality of buttons are provided for user interaction within a first vehicle of the present invention, at least one of said buttons causing a message to be sent (such as a digital honk indicator) to a vehicle in front of said first vehicle and another of said buttons causing a message to be sent (such as a digital honk indicator) to a vehicle behind said first vehicle. In this particular embodiment the plurality of said buttons provided for user interaction are mounted upon or within the steering wheel (400) of the first vehicle. In this particular embodiment four buttons are provided and are presented as 401, 402, 403, and 404 upon the figure. In this particular embodiment, each button has an arrow shape and points in a different direction as shown in the figure. For example, button 401 points upward and is thereby intended to represent a forward pointing direction. Button 402 points downward and is thereby intended to represent a backward pointing direction. Button 403 points right and thereby is intended to represent a rightward pointing direction. Button 404 points left and is thereby intended to represent a leftward pointing direction.

In this particular embodiment the buttons are connected to the local computing device of the first vehicle. The local computing device is configured to respond differently to each of said buttons. In this particular embodiment, when a user presses button 401 (representing a forward pointing direction), a message is sent by the present invention to a vehicle in front of the first vehicle. This is achieved by the local computing device of the first vehicle sending a message to the VLS server indicating that a message should be sent to the vehicle directly ahead using the methods and apparatus described previously. In this particular embodiment the message is a digital honk indicator causing the VLS server to convey a digital honk message to a second vehicle that is directly ahead of said first vehicle. The local computing device of the second vehicle, upon receiving the message from the VLS server, displays a honk sound or honk message to a user of the second vehicle. The honk message may include an indication as to which vehicle and/or from which direction the honk message was sent (in this case from the first vehicle which is behind the second vehicle). In this way the user of the second vehicle receives a honk message and/or sound as well as an indication of the specific vehicle from which is was sent. The honk message may include specific information, such as a “requesting to pass” message as described previously.

In this particular embodiment, when a user of the first vehicle presses button 402 (representing a backward pointing direction), a message is sent by the present invention to a vehicle behind the first vehicle. This is achieved by the local computing device of the first vehicle sending a message to the VLS server indicating that a message should be sent to the vehicle behind using the methods and apparatus described previously. In this particular embodiment the message is a digital honk indicator causing the VLS server to convey a digital honk message to a second vehicle that is directly behind said first vehicle. The local computing device of the second vehicle, upon receiving the message from the VLS server, displays a honk sound or honk message to a user of the second vehicle. The honk message may include an indication as to which vehicle and/or from which direction the honk message was sent (in this case from the first vehicle which is ahead of the second vehicle). In this way the user of the second vehicle receives a honk message and/or sound as well as an indication of the specific vehicle from which is was sent. The honk message may include specific information, such as a “back off” message as described previously. In this way a user of the first vehicle, by pressing button 402, may sent a specific message (“back off”) to a specific vehicle (the one located directly behind) using the unique methods and apparatus described herein.

In some embodiment the user may press a button (such as 401 or 402) to identify a vehicle (such as the one ahead or the one behind respectively) and may take an additional action to specify the particular message, communication, or information request to be made with respect to the identified vehicle. For example a user of the first vehicle may press the button 401 while uttering aloud the phrase “your tail light is out.” In this example the uttered phrase is captured by a microphone of the first vehicle, digitized, and communicated as an audio message to a second vehicle that directly head, the second vehicle being identified by virtue of the press of button 401 as described previously. The message is communicated, for example, as a result of the audio message being sent to the VLS server and routed to the second vehicle using the methods described previously. In this way, the user of the first vehicle was able to send an audio message to the vehicle directly ahead by pressing the appropriate button (402) that indicates the vehicle ahead and by uttering the audio message to be sent.

In an alternate example a user of the first vehicle may press the button 402 while uttering aloud the phrase “I am slowing down to exit.” The uttered phrase is captured by a microphone of the first vehicle, digitized, and communicated as an audio message to a second vehicle that directly behind, the second vehicle being identified by virtue of the press of button 402 as described previously. The message is communicated, for example, as a result of the audio message being sent to the VLS server and routed to the second vehicle using the methods described previously. In this way, the user of the first vehicle is able to send an audio message to the vehicle directly behind by pressing the appropriate button (402) that indicates the vehicle behind and by uttering the audio message to be sent.

In addition, other buttons may be included upon the messaging user interface such as button 403 that indicates a rightward direction and button 404 that indicates a leftward direction. Using these buttons, a user of the first vehicle may selectively send messages and/or alerts and/or communication requests and/or information requests to vehicles that are located to the right of the first vehicle or to the left of the first vehicle respectively. For example, a user of the first vehicle may press the button 403 while uttering aloud the phrase “I am in your blind spot.” The uttered phrase is captured by a microphone of the first vehicle, digitized, and communicated as an audio message to a second vehicle that is directly to of the first vehicle, the second vehicle being identified by virtue of the press of button 403. The message is communicated, for example, as a result of the audio message being sent to the VLS server and routed to the second vehicle using the methods described previously (in this case the message indicating that the identified vehicle is to the right of the first vehicle). In this way, the user of the first vehicle is able to send an audio message to the vehicle directly to his right by pressing the appropriate button (403) that indicates the rightward direction and by uttering the audio message to be sent. Similarly a user of the first vehicle may selectively send an audio message to the vehicle directly to his left by pressing the appropriate button (404) that indicates the leftward direction and by uttering the audio message to be sent.

Thus the messaging user interface as shown in FIG. 3, when combined with the digital honk indicator methods described herein, is a fast and convenient way for a user of a first vehicle to selectively honk one or more other vehicles in his or her immediately vicinity.

In addition, the messaging user interface as shown in FIG. 3, when combined with the voice capture and voice messaging methods described herein, is a fast and convenient way for a user of a first vehicle to verbally communicate with users of other vehicles in his or her immediately vicinity. In addition, the messaging user interface as shown in FIG. 3, when combined with the information request methods described herein, is a fast and convenient way for a user of a first vehicle to request information about other vehicles in his or her immediately vicinity.

The above messaging user interface method is provided as an example by which a user of a first vehicle may identify one or more of a plurality of nearby vehicles as a step in sending a message to, sending an alert to, initiating communication with, and/or requesting information from the identified vehicle based upon its relative location with respect to the first vehicle. That said, a range of other messaging user interface methods may also be used with the methods and apparatus of the present invention, as described previously.

This invention has been described in detail with reference to preferred and alternate embodiments. It should be appreciated that the specific embodiments described above are merely illustrative of the principles underlying the inventive concept. It is therefore contemplated that various modifications of the disclosed embodiments will, without departing from the spirit and scope defined by the following claims, be apparent to persons of ordinary skill in the art.

What is claimed is:

1. An automobile-to-automobile instant-messaging system comprising:
a first automobile and a second automobile, each automobile comprising
a vehicle chassis for transporting a user on a road of travel,
a messaging user interface for enabling the user to selectively indicate message-sending intentions,
a messaging display for selectively displaying a message to the user in at least one of an audio or visual form,
one or more locative sensors for determining a substantially current geospatial location and direction of travel of the automobile,
a wireless communication link for transmitting locative data and message data from the automobile to a locative server, and
a processor operationally connected to the messaging user interface, the one or more locative sensors, and the wireless communication link, the processor running messaging routines; and
the locative server comprising one or more processors, the locative server in wireless communication with each of said first and second automobiles, the locative server repeatedly receiving and storing locative information from each of said first and second automobiles indicating the substantially current geospatial location of that automobile;
wherein the message is routed to the second automobile from the first automobile dependent at least in part upon a detected interaction between the user of said first automobile and the messaging user interface of the first automobile and a determined spatial proximity between the first automobile and the second automobile.

2. The automobile-to-automobile instant messaging system of claim 1 wherein the message is routed dependent at least in part upon a determination that the first automobile and the second automobile are traveling upon the same road of travel.

3. The automobile-to-automobile instant messaging system of claim 1 wherein the message is routed dependent at least in part upon a determination that the first automobile and the second automobile are traveling in the same general direction upon a common road of travel.

4. The automobile-to-automobile instant messaging system of claim 1 wherein the message is routed dependent at least in part upon a determination that the first automobile and the second automobile are traveling in the same lane.

5. The automobile-to-automobile instant messaging system of claim 1 wherein the message is routed dependent at least in part upon a determination that the first automobile is traveling behind the second automobile.

6. The automobile-to-automobile instant messaging system of claim 5 wherein the detected interaction with the messaging user interface of the first automobile indicates that the user of the first automobile wishes to send the message to a vehicle traveling in front of the first automobile.

7. The automobile-to-automobile instant messaging system of claim 1 wherein the message is routed dependent at least in part upon a determination that the first automobile is traveling in front of the second automobile.

8. The automobile-to-automobile instant messaging system of claim 7 wherein the detected interaction with the messaging user interface of the first automobile indicates that the user of the first automobile wishes to send the message to a vehicle traveling behind the first automobile.

9. The automobile-to-automobile instant messaging system of claim 1 wherein the messaging display of the second automobile outputs an alert sound to the user of the second automobile in response to receiving the routed message.

10. The automobile-to-automobile instant messaging system of claim 9 wherein the alert sound is displayed using spatial audio techniques such that it sounds to the user of the second automobile like it is coming from the general direction of the first automobile.

11. The automobile-to-automobile instant messaging system of claim 9 wherein the alert sound emulates the sound of a car horn.

12. The automobile-to-automobile instant messaging system of claim 1 wherein the messaging display of the second automobile outputs visual information indicating the relative location of the first automobile in response to receiving the routed message.

13. The automobile-to-automobile instant messaging system of claim 1 wherein the messaging display of the second automobile outputs descriptive information relating to at least one of the make, model, and color of the first automobile in response to receiving the routed message.

14. The automobile-to-automobile instant messaging system of claim 1 wherein the messaging display of the second automobile outputs information indicating that a user of the first automobile believes the second automobile is at least one of too close, has its brights on, has its blinker on, has a tail light out, and is moving too slowly.

15. The automobile-to-automobile instant messaging system of claim 1 wherein the messaging display of the second automobile outputs information indicating that the user of the first automobile desires to pass the second automobile.

16. An automobile-to-automobile instant-messaging system comprising:
a locative server in wireless communication with processors of each of a first automobile and a second automobile, the locative server repeatedly receiving locative data from each of said first and second automobiles, the locative data indicating the substantially current geospatial location of the respective automobiles;
wherein messaging data is sent to the second automobile that originates from the first automobile, the messaging data being sent dependent at least in part upon a determined spatial proximity between the first automobile and the second automobile; and
a user interface in the first automobile adapted to receive a user interaction indicating the user's desire to send the messaging data to another automobile in the local vicinity of the first automobile.

17. The automobile-to-automobile instant messaging system of claim 16 wherein the messaging data is sent dependent at least in part upon a determination that the first automobile and the second automobile are traveling upon the same road of travel.

18. The automobile-to-automobile instant messaging system of claim 16 wherein the messaging data is sent dependent at least in part upon a determination that the first automobile and the second automobile are traveling in the same road direction.

19. The automobile-to-automobile instant messaging system of claim 16 wherein the messaging data is sent dependent at least in part upon a determination that the first automobile is traveling behind the second automobile.

20. The automobile-to-automobile instant messaging system of claim 16 wherein a display of the second automobile outputs an alert sound to the user of the second automobile in response to receiving the messaging data.

21. The automobile-to-automobile instant messaging system of claim 20 wherein the alert sound is displayed using spatial audio techniques such that it sounds to the user of the second automobile like it is coming from the direction of the first automobile.

22. The automobile-to-automobile instant messaging system of claim 20 wherein the alert sound emulates the sound of a car horn.

23. The automobile-to-automobile instant messaging system of claim 16 wherein a display of the second automobile outputs information indicating the relative location of the first automobile in response to receiving the messaging data.

24. The automobile-to-automobile instant messaging system of claim 16 wherein a display of the second automobile outputs information relating to at least one of the make, model, and color of the first automobile in response to receiving the messaging data.

25. The automobile-to-automobile instant messaging system of claim 16 wherein a display of the second automobile outputs information indicating that the user of the first automobile believes the second automobile is at least one of too close, has its brights on, has its blinker on, has a tail light out, and is moving too slowly.

26. The automobile-to-automobile instant messaging system of claim 16 wherein a display of the second automobile outputs information in response to receiving the messaging data, the information indicating that the user of the first automobile desires to pass the second automobile.

27. A method for automobile-to-automobile instant-messaging comprising:
sending a message to a second automobile in response to a user request imparted upon a messaging user interface of a first automobile, the sending being dependent at least in part upon a determined spatial proximity between the second automobile and the first automobile, and a determined common direction of road travel of the second automobile and the first automobile.

28. The method of automobile-to-automobile instant messaging of claim 27 wherein the sending of the message to the second automobile is further dependent at least in part upon a determination that the first automobile is traveling behind the second automobile.

29. The method of automobile-to-automobile instant messaging of claim 27 wherein the second automobile outputs an alert sound to the user of the second automobile in response to receiving the message.

30. The method of automobile-to-automobile instant messaging of claim 27 wherein a display of the second automobile outputs information indicating the relative location of the first automobile in response to receiving the message.
